(19) United States
(12) Patent Application Publication
(10) Pub. No.: US 2007/0193945 A1
(43) Pub. Date: Aug. 23, 2007

(54) Swelling/contracting filter

(76) Inventors: Tooru Sekiya, Tokyo (JP); Masakatsu Watanabe, Tokyo (JP); Teruo Sugizaki, Tokyo (JP)

Correspondence Address: SMITH PATENT OFFICE, 1901 PENNSYLVANIA AVENUE N W, SUITE 901, WASHINGTON, DC, 20006, US

(21) Appl. No.: 10/593,489

(22) PCT Filed: Mar. 23, 2005
(86) PCT No.: PCT/JP05/05187

§ 371 Date: Sep. 20, 2006

(30) Foreign Application Priority Data
Mar. 25, 2004 (JP) 2004-089091

(51) Int. Cl. B01D 39/00

(52) U.S. Cl. 210/487

(57) ABSTRACT

A swelling/contracting filter comprises a bag-like filtrating cloth allowed to swell and contract and a flow passage material disposed in the filtrating cloth for collecting and discharging a liquid filtrated by the filtrating cloth, and the filter is characterized in that the filtrating cloth and the flow passage material are both formed of flexible materials. Accordingly, the filter itself can be freely bent and folded. As a result, even if the filter is long or densely disposed in a vessel, the filter can be easily handles and removed by bending and folding, and the replacement and maintenance of the filtrating cloth and the filter can be extremely easily performed.

### TECHNICAL FIELD OF THE INVENTION

The present invention relates to a filter device in a filtration apparatus used in various industries for removing suspended substances in liquid by filtrating, and more specifically, to a swelling/contracting type filter using a bag-like filtrating cloth allowed to swell and contract.

### BACKGROUND ART OF THE INVENTION

As a filter (a filtrating module) used in a filtration apparatus for filtrating or concentrating a suspension such as a waste water in various industries or a sludge generated during water purification or sewage treatment or for recovering valuable substances from a waste water in various industries, a filter structured by providing a filtrating cloth via a spacer such as a net onto an outer surface of a hollow cylindrical body made of a hard synthetic resin having many holes for liquid communication on its surface, and a filter structured as a hollow cylindrical filtrating body with a porous material of a hard material such as a ceramic, are known. Further, as disclosed in Patent Document 1, a swelling/contracting filter is also known wherein a filtrating cloth made of a flexible sheet formed to be cylindrical or bag-like (hereinafter, in the present application, these are called “bag-like” as a generic term) is provided around a flow passage material provided as a member for collecting a filtrated liquid, at the time of filtration or stoppage, the filtrating cloth can be turned to a flat structure by contracting the filtrating cloth onto the surface of the flow passage material, and at the time of cleaning the filtrating cloth from the flow passage material side, the filtrating cloth can be turned to a cylindrical or bag-like structure.

Usually such a filter is used as a formation installing a plurality of filters into a vessel, and when the filtrating cloth is replaced and the filter body is exchanged, it is necessary to put the filter out of and into the vessel through a manhole and the like. Although the filtrating cloth is usually made of a flexible material capable of being freely bent and folded, because the flow passage material, which becomes a core material of the filtrating cloth, is formed from a rigid material, the filter itself has been structured so as not to be freely bent. Therefore, especially in a case where a long filter is installed in a long vessel, the work for installation, replacement, etc. has been difficult. Further, in a case where a number of filters are installed in a vessel in parallel to each other, it has been extremely difficult to repair or replace only a specified filter. Furthermore, even when the filter is packed, transported or stored, a large space is required, and it has caused an inconvenience and a cost.

Further, in the aforementioned swelling/contracting filter, because it is formed as a flat shape at the time of filtration and the inside space is small, there is a case where the discharge of the filtrated liquid is not performed enough, and there is a fear that there occurs a problem in discharge performance of filtrated liquid. A problem is also left that the liquid collection cannot be sufficiently carried out by the net structure or a structure for collecting the liquid to a central part of the filter, and a sufficient ability for discharging the filtrated liquid, ultimately, a sufficient filtration ability, may not be exhibited.

Furthermore, for the purpose of breakaway recovering or breakaway cleaning of the filtration residual accumulated on the surface of the filtrating cloth accompanying with the progress of the filtration, a filtration performance recovery operation is carried out wherein air is blown momentarily into the filtrating cloth from an attachment tube for the filtrating cloth and the air is discharged from the inner surface of the filtrating cloth to the outer surface of the filtrating cloth. At that time, although it is required to uniformly disperse the air on the inner surface of the filtrating cloth, in the conventional device, there is a fear that the dispersion of the air may be ununiform and there is a fear that it becomes difficult to break away the filtration residual uniformly over the entire surface of the filtrating cloth. Patent Document 1: Japanese Patent 2,766,959

### DISCLOSURE OF THE INVENTION

Problems to be Solved by the Invention

Accordingly, paying attention to the problems in the conventional filters, in particular, the problem in the conventional swelling/contracting filter that the structural member such as the flow passage material is made of a hard material, and therefore, the bending and folding of the filter at the time of transportation, attachment, detachment or replacement is difficult and the difficulty becomes an obstacle against these works, an object of the present invention is to provide a swelling/contracting filter in which, without causing such an inconvenience, the filter itself can be freely bent and folded.

Further, the present invention aims, when such an easy handling swelling/contracting filter is formed, to enable to employ a structure which can solve the inconvenience that may occur in the conventional apparatus.

Means for Solving the Problems

To achieve the above-described objects, a swelling/contracting filter according to the present invention comprises a bag-like filtrating cloth allowed to swell and contract and a flow passage material disposed in the filtrating cloth for collecting and discharging a liquid filtrated by the filtrating cloth, and is characterized in that the filtrating cloth and the flow passage material are both formed of flexible materials, respectively.

In this swelling/contracting filter, as the above-described flow passage material, a plate-like material can be used. Further, as a concrete material of the flexible material forming the flow passage material, although it is not particularly limited as long as it is a material having flexibility, in particular, a material having a high flexibility such as a soft rubber material or a flexible plastic sheet is preferable. Moreover, it is preferred that the flow passage material is provided with a groove extending in a direction in which the filtrated liquid is discharged. Although the shape of the groove is not particularly limited and the groove may have adequate width and depth, it is preferred that a plurality of grooves are provided on both surfaces of the flow passage material, respectively, in parallel to each other.

Further, it is preferred that the width of the flow passage material is set to be equal to or less than an inner diameter of the filtrating cloth determined when the filtrating cloth is swelled in a cylindrical form.

In the swelling/contracting filter according to the present invention thus constructed, because the filtrating cloth and the flow passage material are both formed of flexible materials, respectively, it becomes possible to give a flexibility capable of being bent and folded to the whole of the filter (filtration module). Generally, filtration modules are attached in a vessel at a dense condition. Further, because of clogging of the filtration surface due to use for a long time, it is necessary to detach the filtration module from the vessel for replacing or cleaning the filtrating cloth of the filtration module and carry out the recovering work of the filtration surface. In such a detachment work, in the present invention, since the bending and folding of the filter being the working target become possible, a minimum-sized vessel opening (for example, a manhole) may be present at the time of taking out the filter from the vessel, and the working also becomes easy. Further, the handling thereof in the vessel also becomes a very easy working, and the space in the vessel required for the working may be minimum.

In the conventional apparatus, in particular, as the filter becomes longer, the work for taking out the filter becomes more difficult, and there occurs a case where the filter has to be taken out by disassembling the whole of the vessel, etc. In a long and large-sized apparatus, however, such a disassembly of the whole is frequently difficult, and consequently, such a large-sized apparatus has not been able to be designed and manufactured. In order to solve such a problem, the present invention provides a swelling/contracting filter in which bending and folding can be carried out freely or very easily, and the swelling/contracting filter according to the present invention can solve the difficulty of the taking out and enable to design and manufacture a long and large-sized apparatus.

Further, a filter smooth in collection of filtrated liquid and easy in breakaway recovery of filtration residual has been required. If the collection of filtrated liquid is not smooth, the filtration ability reduces, and if the breakaway of filtration residual is insufficient, because the filtration area at the surface of a filtrating cloth decreases, the filtration ability also reduces. In the swelling/contracting filter according to the present invention, by providing a groove extending in the filtrated liquid-discharge direction to the flow passage material, particularly, by providing a plurality of grooves on both surfaces of the flow passage material, respectively, it becomes possible to collect and discharge the filtrated liquid smoothly along the grooves. Further, as to filtration residual trapped at filtration, it is desired to break away the filtration residual over the entire surface of the filtrating cloth in order to recover the surface of the filtrating cloth, and the grooves provided on the flexible flow passage material serves to enable a smooth movement of the filtrated liquid and a momentary filling of air introduced momentarily at the time of the breakaway of the filtration residual over the entire of the inside of the filter, thereby breaking away the filtration residual over the entire surface of the filtrating cloth.

Further, in such a swelling/contracting filter having a flexible flow passage material, when gas such as air is blown into the filter in order to break away the filtration residual, the filtrating cloth swells at a circular form in cross section, and at that time, there is a case where the flow passage material dances by the affection of the flow of the blown gas and it is bent or twisted. At that time, if the width of the flow passage material is greater than the inner diameter of the swelled filtrating cloth, because the ends of the flow passage material in its width direction are brought into contact with and held by the inner surface of the filtrating cloth, there is a case where the bent or twisted flow passage material is left at the deformed condition without returning to the original form even after the supply of the gas is stopped. If the filtrating cloth is contracted again to be turned to its flat condition at such a condition where the deformation of the flow passage material is kept, the filtrating cloth is turned to a flat condition along the deformed condition of the flow passage material, and at such a condition, the filtration is carried out. In such a condition, there is a fear that the filtrating cloth or the flow passage material is broken from the part bent or twisted, or that the flow of the gas for breakaway and removal of the filtration residual after filtration is disturbed, the breakaway is carried out partially, and a good recovery of the filtration surface cannot be achieved. Therefore, by setting the width of the flow passage material to be equal to or less than the inner diameter of the filtrating cloth determined when the filtrating cloth is swelled in a cylindrical form, the flow passage material can be in a condition completely free in the swelled filtrating cloth or in a condition equal thereto, even if the flow passage material is bent or twisted at the time of blowing gas into the filtrating cloth, the flow passage material naturally and easily returns to an original normal condition at the time of stopping the gas blowing, the filtrating cloth can contract at a flat form along the flow passage material returned to the original normal condition, and therefore, the above-described inconvenience can be prevented from occurring. Further, by setting the width almost equal to the inner diameter of the filtrating cloth, the flow passage material does not become an obstruction factor to the cylindrically swelling of the filtrating cloth, an uniform blowout of air for breakaway of the filtration residual from the entire surface of the filtrating cloth at the time of blowing gas such as air into the filtrating cloth can be ensured, the breakaway of the filtration residual is carried out completely and uniformly and a desirable recovery of the filtration surface can be achieved, and therefore, a stable repeated filtration operation can be carried out. Further, in a case of a long filter, although there is a fear that the work for inserting a flow passage material into a filtrating cloth becomes relatively troublesome, the insertion becomes relatively easy by setting the width of the flow passage material to be equal to or less than the inner diameter of the filtrating cloth, as described above.

In the above, in a case where the width of the flow passage material is set less than the inner diameter of the filtrating cloth, because there is a fear that the amount of the filtrated liquid passing along the flow passage material becomes smaller and the amount of air introduced also becomes smaller, it is desirable to make the aforementioned groove width and groove depth great. However, if the groove depth is to great, because a problem such as destruction may occur at the time of making the filtrating cloth flat, it is preferable to set the groove width at about 3-5 mm at greatest. Further, even in a case where the width is set at a width almost equal to the inner diameter, because, at the time of making the filtrating cloth flat, a flat condition portion projecting from the width of the flow passage material is formed and this portion forms a filtration surface which does not come into contact with the flow passage material, a reduction of the flow of the filtrated liquid due to this portion may be considered. According to the result of experiment, however, such a reduction of the flow of the filtrated liquid was not observed, even if the above-described flat portion of the filtrating cloth projecting from the flow passage material existed, the same performance was exhibited. This is considered that, because a flow toward the flow passage material ascribed to permeation at the surface of the filtrating cloth and the inside of the filtrating cloth exists, it does not become a problem in practice.

Effect According to the Invention

In the swelling/contracting filter according to the present invention, since the filtrating cloth being swelled and the flow passage material being disposed therein are both formed of flexible materials and the filter can be easily bent and folded as a whole, even in a case of a long filter, or even in a case where the filters are densely disposed in a vessel, it becomes possible to easily handle and take out the filter by bending or folding the filter. Therefore, the replacement of the filtrating cloth or the filter can be easily performed, and it becomes possible in practice to design or manufacture a long swelling/contracting filter and a filtration apparatus using it in consideration of the replacement and the maintenance thereof. Further, it also becomes possible to perform the transportation and the storage easily.

Further, by providing grooves to the flow passage material or by adequately setting the relationship between the width of the flow passage material and the inner diameter of the filtrating cloth, in addition to the above-described improvement of the handling ability, the filtration performance and the performance for breaking away and removing the filtration residual may be improved.

### BRIEF EXPLANATION OF THE DRAWINGS

FIG. 1 is a vertical sectional view of a filtration apparatus using a swelling/contracting filter according to an embodiment of the present invention.

FIG. 2 is an enlarged vertical sectional view of an attachment portion of the swelling/contracting filter to a partition in the apparatus depicted in FIG. 1.

FIG. 3 is an enlarged perspective view of a portion of a hanging tool in the mechanism depicted in FIG. 2.

FIG. 4 is an enlarged perspective view of an attachment pipe in the mechanism depicted in FIG. 2.

FIG. 5 is an enlarged cross-sectional view of the swelling/contracting filter depicted in FIG. 2, as viewed along line V-V of FIG. 2.

### EXPLANATION OF SYMBOLS

1: filtration apparatus

2: vessel

2a: vessel part for upper chamber

2b: vessel part for lower chamber

3: partition

4: upper chamber

5: lower chamber

6: swelling/contracting filter

7a, 7b: manhole

8: introduction pipe for liquid to be treated

9: pipe for filtrated liquid

10: air introduction pipe

11: filtrating cloth

12: flow passage material

13: attachment pipe

14: attachment nut

15: packing presser foot

16: packing

17: hardware for attachment of filtrating cloth

18: hanging tool

19: attachment member

20: hanging string

21: groove

### THE BEST MODE FOR CARRYING OUT THE INVENTION

Hereinafter, a desirable embodiment of the present invention will be explained referring to figures.

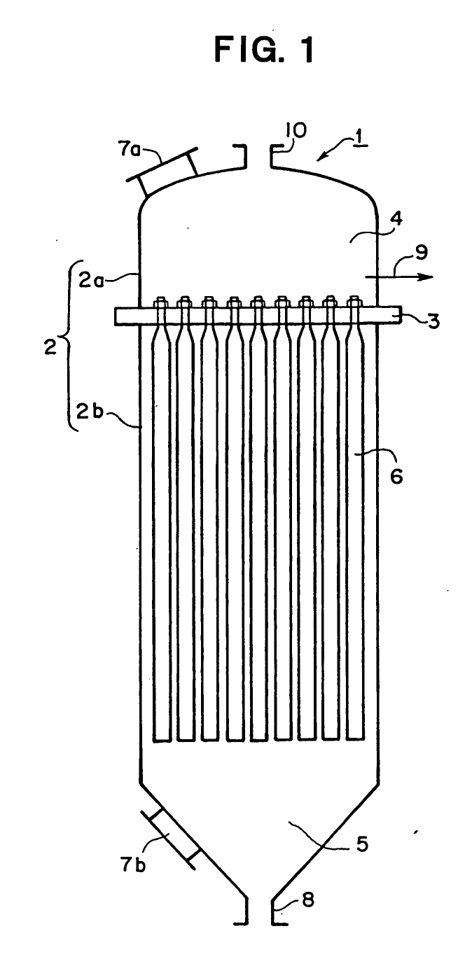

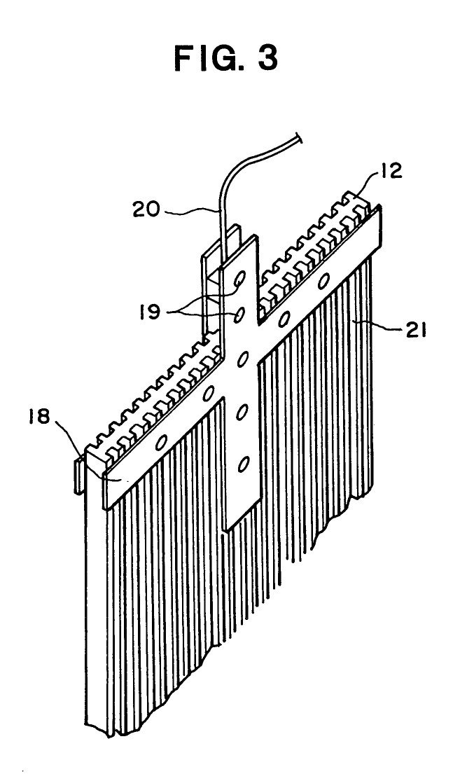

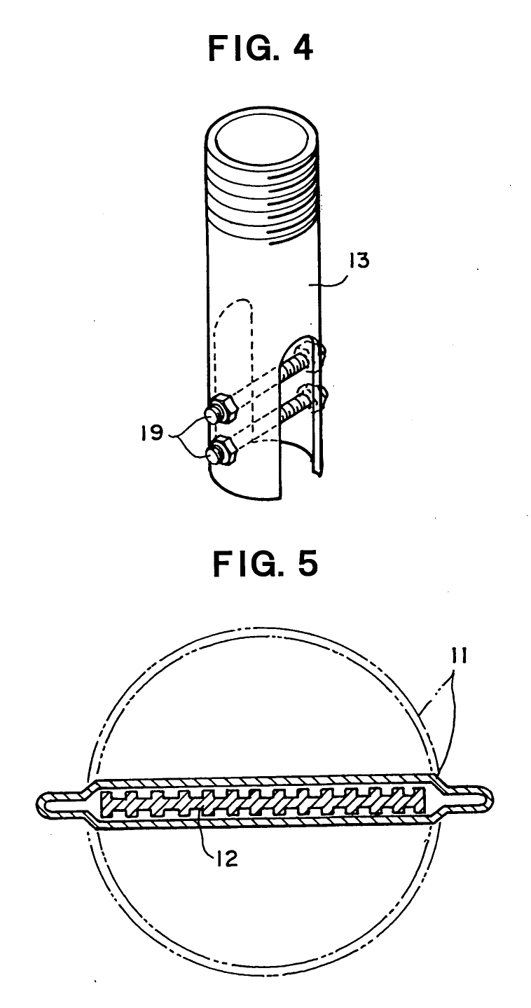

FIGS. 1 to 5 show a swelling/contracting filter according to an embodiment of the present invention and a filtration apparatus using it. FIG. 1 shows the schematic structure of the whole of a filtration apparatus 1, and the inside of a vessel 2 is sectioned into an upper chamber 4 and a lower chamber 5 by a partition 3. A plurality of swelling/contracting filters 6 are disposed in this lower chamber 5, and each filter 6 is hanged in the vertical direction from partition 3 at a condition where its upper end is fixed to the partition 3. Vessel 2 is divided into a vessel part for upper chamber 2a and a vessel part for lower chamber 2b via partition 3, and manholes 7a and 7b are provided to the vessel part for upper chamber 2a and the vessel part for lower chamber 2b, respectively, for serving for various maintenance works and other works such as replacement of a filtrating cloth and installation and exchange of filters. During the operation of filtration, the liquid to be treated, which is introduced into lower chamber 5 through an introduction pipe for liquid to be treated 8, is filtrated by filters 6, and the treated liquid removed with suspended substances and the like is discharged to a predetermined destination from upper chamber 4 through pipe for filtrated liquid 9. When the filtration residual trapped on the filtration surface of the swelling/contracting filter 6 is broken away and removed, air is introduced momentarily from an air introduction pipe 10 into upper chamber 4, the air is discharged from the inner surface side of the filtrating cloth of each filter 6 to the outer surface side and the filtration residual is broken away and removed.

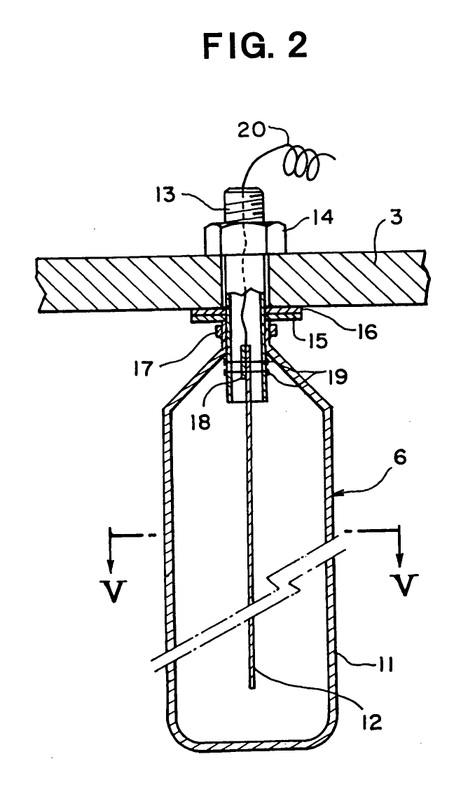

As shown in FIGS. 2 to 5, swelling/contracting filter 6 comprises a filtrating cloth 11 made of a flexible material and formed as a bag-like shape capable of being swelled and contracted, and a flow passage material 12 disposed in the filtrating cloth 11 and made of a flexible material (for example, a rubber material having a flexibility) for collecting the liquid filtrated by the filtrating cloth 11 and discharging the filtrated liquid into upper chamber 4. In the attachment of this filter 6 to the partition 3, an attachment pipe 13 is inserted into an opening of the partition 3 from the lower side, it is attached by an attachment nut 14 via a packing presser foot 15 and a packing 16 so that a leakage does not occur between lower chamber 5 and upper chamber 4. This attachment pipe 13 forms a filtrated liquid exit portion for sending the liquid filtrated by the swelling/contracting filter 6 into upper chamber 4. Filtrating cloth 11 is attached to the outer circumferential surface of attachment pipe 13 at its upper end portion via a hardware for attachment of filtrating cloth 17. The upper end portion of flow passage material 12 is attached to a hanging tool 18, and the hanging tool 18 is coupled to attachment pipe 13 via attachment members 19. In this embodiment, a hanging string 20 is connected to hanging tool 18, and the hanging string 20 extends to the side of upper chamber 4 through attachment pipe 13. This hanging string 20 is used when swelling/contracting filter 6 is attached and detached, as described later.

In this embodiment, flow passage material 12 is formed as a plate-like member, and the width of the flow passage material 12 is set to be equal to or less than the inner diameter of filtrating cloth 11 when it is swelled at a cylindrical form. A plurality of grooves 21 extending in the longitudinal direction (in the discharge direction of the filtrated liquid) are provided in parallel to each other on both surfaces of this flow passage material 12, respectively. At the time of the operation for filtration, filtrating cloth 11 is formed as a flat shape as a whole by being pressed onto the surfaces of flow passage material 12 by the filtration pressure, as shown by the solid line in FIG. 5, and when air is supplied into the interior thereof for breaking away and removing the filtration residual, as shown by the two-dot chain line, the filtrating cloth 11 is swelled at a circular cross-sectional shape, that is, at a cylindrical form as a whole. Grooves 21 function as a flow path for collection of liquid and for filtrated liquid during the operation of filtration, and at the time of breaking away of the filtration residual, they function as a air flow path, that is, a flow path for guiding air in order to uniformly deliver the air in the interior of filtrating cloth 11.

In such a filtration apparatus 1, at the time of filtration, lower chamber 5 is filled with liquid, and is in a pressurized condition for keeping a filtration pressure. The liquid being treated is introduced at a pressurized condition from introduction pipe 8 provided at the lower portion and is discharged through pipe for filtrated liquid 9 after a predetermined process time. The filtrated liquid filtrated by filtrating cloth 11 in the filtration process flows along the flow path formed by the vertical grooves 21 of flexible flow passage material 12 disposed in the filtrating cloth 11, and after being collected in upper chamber 4 through attachment pipe 13, the liquid is discharged out of the apparatus through pipe for filtrated liquid 9. FIG. 5 shows the filtrating cloth 11 at a contracted flat condition in a pressurized condition during filtration. In this condition, the filter 6 is in a flat condition, and the flow passage material 12 and the filtrating cloth 11 are in a condition at a tight contact with each other. Because filtration residual is accumulated around filtrating cloth 11 and the filtration ability is decreased by the progress of filtration, it is necessary to remove the filtration residual periodically. In the removal process, the filtration is stopped, introduction pipe 8 for liquid to be treated is opened, pressurized air is introduced from air introduction pipe 10 to swell filtrating cloth 11 at a circular form as shown by the two-dot chain line in FIG. 5 by introducing the air in the inner surface side of the filtrating cloth 11, the filtration residual is broken away when the air is released toward the outer surface side of the filtrating cloth 11, and cleaning and recovering of the filtration surface is carried out. Where, in a case where the filtration residual is recovered as a concentrated substance, this recovery via the breaking away by the air is carried out, and in a case where such a recovery of the concentrated substance is not required, the operation of introducing pressurized water from air introduction pipe 10 and cleaning by the water is also carried out (backwash).

If the operation of filtration apparatus 1 is continued for a long period, the clogging of filtrating cloth 11 or the breakage ascribed deterioration is inevitable, and therefore replacement of the filtrating cloth 11 is required. In such a case, for example, it is necessary that operators enter into upper chamber 4 and lower chamber 5 through manholes 7a and 7b, and taking attachment nut 14 off and using hanging string 20, filter 6 is taken down into the lower chamber 5 and taken out of the apparatus through the manhole 7b. In this operation, if the longitudinal dimension of the filter 6 is greater than the inner diameter of the vessel of the apparatus, the handling in the inside is very inconvenient and the work for taking the filter out through the manhole 7b becomes difficult or impossible. As the case may be, it becomes necessary to disassemble the vessel of the apparatus, take away vessel part for upper chamber 2a and remove partition 3, and to provide another rack and carry out the operation for taking off at that place. In such a case, a heavy machine such as a crane is required, and a great cost is required for the operation. In order to facilitate this operation, by forming filter 6 with flexible filtrating cloth 11 and flexible flow passage material 12, the filter 6 can be freely bent and folded, and therefore, the operation is not affected by the restriction of the vessel of the apparatus. Therefore, it becomes possible to design and manufacture even a long-sized filter, and by making respective filters 6 long, it becomes possible to enlarge the filtration area and make the installation area of the filtration apparatus even if the filtration area is same. Although a conventional filter has not been manufactured at a length more than 2 m because of the difficulty of the handling thereof, by employing the present invention, it becomes possible to manufacture a long filter with a length of 3 to 10 m or more. In a long filter, because the filtration area can be increased by an amount corresponding to the amount of the increased length per one filter and the diameter of the vessel can be decreased by the increased amount of the filtration area, and further, because the number of the filters can be decreased at the same condition in filtration area, a great cost saving becomes possible. Further, also in storage and transportation, because it can be folded, there is a merit that it does not require a great space and the handling is easy. Where, by using the above-described hanging string 20, even when filtration apparatus 1 is assembled initially, the long filter 6 can be easily handled and can be pulled up to and attached at a predetermined position, and therefore, the operation can be greatly facilitated.

Further, by providing vertical grooves 21 to flexible flow passage material 12, the movement of the filtrated liquid becomes smooth and it becomes possible to collect the liquid smoothly from the entire filtration surface even in a case of a long filter 6. In particular, in a field where a large amount of filtrated liquid is collected, coping with such a use can be easily achieved by enlarging the depth of the vertical grooves. Furthermore, another advantage of the vertical grooves 21 is to able to perform the operation of the break away and recovery of the filtration residual, which is carried out by releasing air from the inner surface side of filtrating cloth 11 for the purpose of the break away and recovery of the filtration residual, at a desirable condition. In this operation, it is necessary to swell filtrating cloth 11 in a short time as uniformly as possible. In order to deliver the air uniformly and momentarily to the inner surface of filtrating cloth 11, it is necessary that the air flows in up to the end portion of the filter which has been contracted and formed flat at the time of filtration, and therefore, it is important to ensure the air flow path up to a portion near the end portion. Since vertical grooves 21 of flow passage material 12 are provided so that the flow path is formed uniformly on each surface of the flow passage material 12 and there is nothing to interrupt the flow path, even in a long filter 6, a smooth breaking away structure over the entire surface can be achieved. If this air distribution is not performed smoothly, it is required to use a large amount of air or to repeat the same operation a plurality of times. In the present invention, however, the amount of used air is suppressed small and the number of the operations may be small. Also in backwash with a liquid such as water, similarly the vertical grooves 21 exhibit an advantage for distributing the liquid over the entire interior of the filtrating cloth 11.

Further, the following advantages can be obtained by setting the width of flexible flow passage material 12 at a width equal to or less than the inner diameter of the swelled filtrating cloth 11. Although there is a case where flow passage material 12 dances and it is bent or twisted by an air flow when fluid such as air is blown into filtrating cloth 11, if the width of the flow passage material 12 is greater than the inner diameter of the filtrating cloth 11, there is a fear that the flow passage material 12 is held at a deformed state such as a bent or twisted condition by the contact of the end portions in the width direction of the flow passage material 12 with the inner surface of the filtrating cloth 11 even after stopping of the air blowing, and because the flat condition is formed at such a condition and filtration is performed, there is a fear that a breakage occurs from the bent portion, or that the air flow for break away for breaking way and removing the filtration residual after finishing the filtration is disturbed, only a partially breaking away is performed, and well recovered filtration surface cannot be achieved. By setting the width of flow passage material 12 at a width equal to or less than the inner diameter of the swelled filtrating cloth 11, even if bending or twisting occurs at the time of air blowing, the shape of the flow passage material 12 returns to its original shape at the time of stopping the air blowing, and it is surely prevented that the flow passage material 12 is contracted to a flat form for the following filtration at a condition where the flow passage material 12 is kept at its deformed condition. Therefore, the operation of filtration and the operation for breaking away and removal of the filtration residual are repeated at desirable conditions, and the operation of filtration and the recovery of the filtration surface are stably performed at a desirable state. Further, by setting the width of flow passage material 12 at a width equal to or less than the inner diameter of the swelled filtrating cloth 11, the work for inserting the flow passage material 12 into the filtrating cloth 11 is also facilitated.

### INDUSTRIAL APPLICATIONS OF THE INVENTION

The swelling/contracting filter according to the present invention can be used for any filtration apparatus using swelling/contracting filters, which is used for filtration, concentration or recovery in the treatment of various industrial waste water or sewage treatment, and in particular, it is suitable for a long and large-sized filtration apparatus.

1. A swelling/contracting filter comprising a bag-like filtrating cloth allowed to swell and contract and a flow passage material disposed in said filtrating cloth for collecting and discharging a liquid filtrated by said filtrating cloth, characterized in that said filtrating cloth and said flow passage material are both formed of flexible materials, respectively.

2. The swelling/contracting filter according to claim 1, wherein said flow passage material comprises a plate-like material.

3. The swelling/contracting filter according to claim 1, wherein said flow passage material is provided with a groove extending in a direction in which said filtrated liquid is discharged.

4. The swelling/contracting filter according to claim 3, wherein a plurality of grooves are provided on both surfaces of said flow passage material, respectively.

5. The swelling/contracting filter according to claim 1, wherein a width of said flow passage material is set to be equal to or less than an inner diameter of said filtrating cloth determined when said filtrating cloth is swelled in a cylindrical form.
